(19) United States
(12) Patent Application Publication
(10) Pub. No.: US 2020/0306634 A1
(43) Pub. Date: Oct. 1, 2020

(54) VR device for generating and displaying a virtual reality

(71) Applicant: VR COASTER GMBH & CO. KG., Kaiserlautern (DE)

(72) Inventor: Dennis GORDT, Sexau (DE)

(21) Appl. No.: 16/758,805

(22) PCT Filed: Oct. 5, 2018
(86) PCT No.: PCT/EP2018/077209

§ 371 Date: Apr. 23, 2020

(30) Foreign Application Priority Data
Oct. 24, 2017 (DE) 17198096.4

(51) Int. Cl. A63F 13/428; A63F 13/285; G02B 27/01; A63F 13/52

(52) U.S. Cl. CPC A63F 13/428; A63F 13/52; G02B 27/0176; A63F 13/285

(57) ABSTRACT

The present invention relates to a VR device for generating and displaying a virtual reality, comprising a VR segment (12) within which at least one user (16) and at least one object (18) can move freely, the VR device having means by which a virtual reality corresponding to the position and movements of the user (16) and the object (18) in the VR segment (12) can be generated and can be displayed on a head-mounted display (21) assigned to the user (16), dependent on the position and the movement of the user (16) in the VR segment (12), and having a position sensing device (24) for sensing the position and the movements of the user (16) and the object (18) in the VR segment (12), the object (18) having a surface, the haptics of which are adapted to the haptics to be anticipated according to the virtual reality.

The present invention relates to a VR device for generating and displaying a virtual reality.

Due in particular to the expanding processing capacity of computers and the ability to transmit increasing volumes of data wirelessly, the concept of virtual reality (VR) is moving into more and more areas of application. VR concepts can be used in theme parks, fitness studios, or escape rooms in recreation and gaming centers, as is demonstrated, for example, in WO 2013/050473 A1. The theme parks, fitness studios, and escape rooms each represent a VR segment in which the virtual reality is accessible to a user. Head-mounted displays such as VR glasses are typically used for this purpose. Such head-mounted displays are disclosed in US 2013/0083003 A1.

To enhance the appeal of the virtual reality, virtual objects can be incorporated into the virtual reality. These objects may be in the form of fantasy figures such as knights or monsters. To achieve a comprehensive immersion, i.e. an impression of the virtual reality that feels as real as possible, when the user comes into contact with the object, the external shape and/or haptics of the objects must match the external shape and/or haptics anticipated by the user according to the virtual reality. If the external shape and haptics of the objects perceived by the user deviate too much from the haptics to be anticipated according to the virtual reality, immersion will be impaired.

The external shape and haptics of virtual objects are reproduced using haptic gloves, which are also referred to as “feedback devices” and which are worn by the user of the virtual reality. External shape and haptics are closely related. For a comprehensive immersion, when a user touches the surface of a virtual object in the virtual world he should receive corresponding feedback via the haptic gloves. The goal should be for the user to receive feedback that he is touching the surface, which can be achieved, for example, by the impression of resistance. Additionally, however, the haptics should correspond to what would be anticipated from the virtual reality.

But the haptics that can be realized using the haptic gloves available as of the priority date of the present application are consistent to only a limited extent with the haptics to be anticipated from the virtual reality. Moreover, the technical and monetary expenditure required to use the haptic gloves is very high, which is why haptic gloves are relatively rarely used.

The object of one embodiment of the present invention is to provide a VR device that makes it possible to integrate objects, in particular freely movable objects, into virtual reality in a simple and cost-effective manner, in which the external shape and haptics of said objects correspond to the external shape and haptics that would be anticipated according to the virtual reality.

This object is attained by the features specified in claim 1. Advantageous embodiments are the subject of the dependent claims.

One embodiment of the invention relates to a VR device for generating and displaying a virtual reality, comprising a VR segment within which at least one user and at least one object can move freely, the VR device having means by which a virtual reality corresponding to the position and the movements of the user and the object in the VR segment can be generated and can be displayed on a head-mounted display assigned to the user, dependent on the position and the movement of the user within the VR segment, and having a position sensing device for sensing the position and the movements of the user and the object within the segment, wherein the object has an external shape that is adapted, at least in terms of its geometric shape and size, to the external shape that would be anticipated according to the virtual reality.

The means by which a virtual reality corresponding to the position and the movements of the user and the object in the VR segment can be generated and displayed on a head-mounted display assigned to the user dependent on the position and the movement of the user in the VR segment typically comprises a processing unit that processes the signals from the position sensing device and uses them to generate the virtual reality. The virtual reality generated in this way is transmitted to the head-mounted display in particular wirelessly by means of a transmitting device, which displays the virtual reality to the user.

For sensing the position and the movements of the user and the object in the VR segment, the position sensing device comprises a number of sensors, which are arranged in the VR segment and which sense the position and the movements optically, for example, and convert them into corresponding signals.

The at least one object has an external shape that is adapted at least in terms of its geometric shape and size to the external shape that would be anticipated according to the virtual reality. As mentioned at the outset, the objects may be configured as knights or monsters, which are integrated into the virtual reality. They are therefore objects that are physically present in the real world and not virtual objects that exist only in the virtual reality. It is therefore possible, for example, to provide the mobile object with an external shape a user would anticipate from a knight's armor. In particular, the knight can carry a sword and/or a shield. The external shape of the object can be adapted to this in terms of its geometric shape and size.

According to the proposal, a simple and cost-effective option is thus created for enhancing the immersion and for offering the user an intense experience of the virtual reality.

According to a further embodiment, the VR device comprises one or more shaped elements, which can be attached to the object and the external shape of which is adapted to the external shape that would be anticipated according to the virtual reality. Immersion is enhanced by the fact that where an object is anticipated according to the virtual reality, an object is actually encountered. For example, if the monster has outwardly extending flippers, the shaped elements can be shaped to simulate the flippers. The shaped elements may be made of foam or other easily shaped materials, so that the external shape of the object can be easily adapted to the external shape to be anticipated according to the virtual reality. If the shaped element is detachably attached to a given object, in particular, the external shape of the object can be adapted to a different virtual reality with little effort. For example, the external shape of the object can be simulated on a monster in one virtual reality and on a knight in another virtual reality. Shields and swords are available as toy articles, which can be used as inexpensive shaped elements.

In a further embodiment, the surface of the object has haptics that are adapted to the haptics that would be anticipated according to the virtual reality. As mentioned above, the objects may be configured as knights or monsters that are integrated into the virtual reality. According to the proposal, the object may be provided with a metallic surface that has haptics a user would expect from the knight's armor. Depending on the design of the monster, the mobile object may have a hairy and/or moist surface. Such a surface can be achieved easily by using a suit or a cape.

In a further refined embodiment, the shaped element can be configured as an inflatable sleeve. The inflatable sleeve can be easily attached to and removed from the object. Inflatable sleeves can have multiple chambers that may or may not be inflated, depending on the external shape of the object. This enables the external shape of the object to be adapted quickly, for example, to the external shape of the monster or the knight to be anticipated according to the virtual reality. Moreover, the inflatable sleeve can be inflated to a greater or lesser extent, allowing the degree to which the sleeve yields when pressure is applied to be adjusted. Thus, a more or less yielding shaped element can be provided, depending on the expectations of the user according to the virtual reality.

In a further refined embodiment, the surface can be formed by the shaped element. As explained above, the shaped element serves primarily to adapt the external shape of the object to the external shape to be anticipated according to the virtual reality. As has already been explained, the embodiment of the shaped element as an inflatable sleeve enables the degree of yielding to be adjusted thereby. According to this embodiment, the shaped elements also form the external surface, so that in addition to determining the external shape and the degree of yield, the shaped elements also determine the haptics of the surfaces. This facilitates in particular the adaptation of the objects to different virtual realities.

In a further embodiment, the object can have movable sections and the position sensing device can have position sensors that can be attached to the object and can be used to sense the movements of the movable sections. As mentioned at the outset, the position sensing device is configured such that it can sense the position and the movements of the user and the object in the VR segment. For this purpose, the position sensing device has a number of sensors arranged in the VR segment, but these are not arranged on the object or on the user. In contrast, according to this embodiment the position sensors are arranged on or in the movable sections of the object. This enables even small movements of the movable sections to be sensed accurately, enhancing immersion.

A further refined embodiment is characterized in that the VR device comprises a scent producer for producing scents that are adapted to the scents that would be anticipated according to the virtual reality. For example, if the monster has a moist surface, a musty decay-like scent provided by the scent producer can enhance immersion further.

According to a further embodiment, the object may be a robot or a natural person. If the object is a robot, sensing its position and movement is easier in that it is established before the first use in the VR segment or in that the robot can communicate its current position to the position sensing device. In the case of natural persons, sensing the position and the movement is more complex because they can be predetermined only to a very limited extent. The position sensors that can be attached to the object are therefore particularly suitable for use with natural persons. For this purpose, active or passive “motion capture markers” can be used, which can be pinned to the natural person and can be used to convert movement into a format that can be read by the position sensing device. The position sensors can also be used to sense movements of the mouth of natural persons and to generate corresponding sounds that are adapted to sounds that would be anticipated according to the virtual reality. The use of natural persons as objects that can move within the VR segment has the advantage that they respond better to the user's reactions and can thus intensify the user's experience in the VR segment. In addition, natural persons can be used more flexibly in general and can adapt more quickly to different virtual realities.

According to a further embodiment, the VR device comprises a route specifying means, which is configured such that the object moves along a predefined route within the VR segment. This route specifying means is particularly useful if the object is in the form of a robot. However, the route specifying means can be used even if the object is in the form of a natural person. In either case, the presence of the object within the VR segment can be largely evenly distributed, and the probability that every user in the VR segment will come into contact with the object can be maximized.

The VR device can further comprise a route specifying means that is configured such that the object moves along a route that is not predefined within the VR segment. In other words, the object can move randomly within the VR segment. The random movement of the object within the VR segment will usually occur naturally with natural persons. If the object is designed as a robot, the route must typically be predefined, for example to prevent the robot from leaving the VR segment. As mentioned above, this can ensure that the robot's presence is largely even throughout the VR segment and does not omit certain areas. However, this limits the flexibility of the robot. If, on the other hand, the route specifying means is configured such that the object moves along a route that is not predefined within the VR segment, the robot can, for example, interact with a user for a longer time and can adjust to the user's movements. This enhances immersion further.

Exemplary embodiments of the invention will be explained in greater detail below with reference to the accompanying drawings. In the drawings,

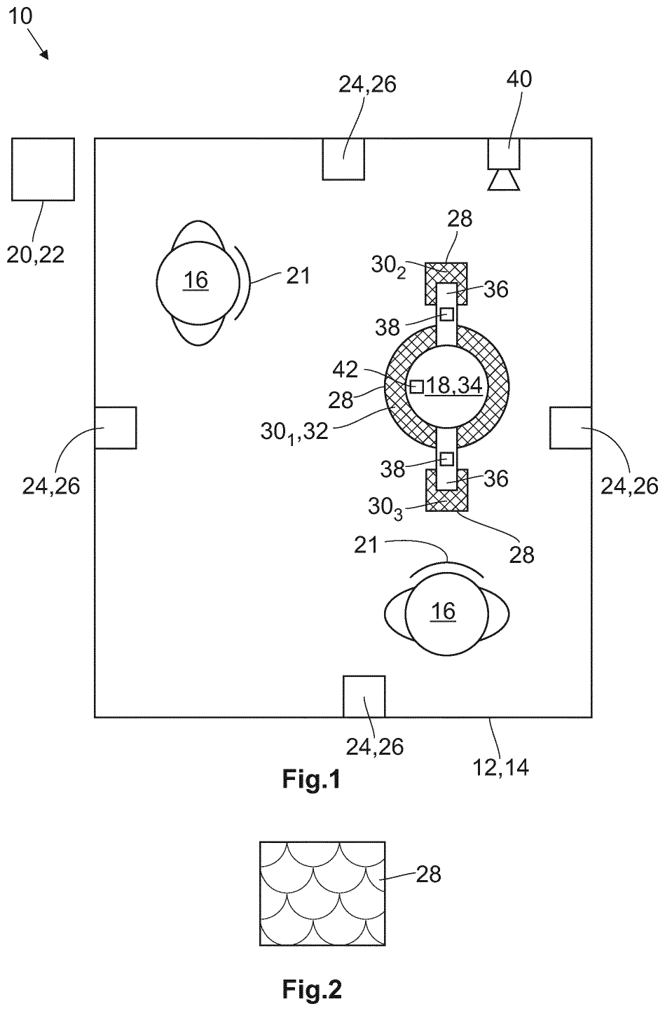

FIG. 1 shows a basic plan view of a VR device according to the invention, and

FIG. 2 shows a schematic depiction of a surface of an object of the VR device according to the invention.

FIG. 1 shows a VR device 10 according to the invention in a basic plan view. VR device 10 comprises a VR segment 12, which is delimited by means of a virtual and/or by means of a real wall 14. At least one user 16 and at least one object 18 can move freely within VR segment 12. VR device 10 further has means 20 by which a virtual reality corresponding to the position and the movements of the user 16 and the object 18 in VR segment 12 can be generated and can be displayed on a head-mounted display 21 assigned to the user 16, dependent on the position and the movement of user 16 and object 18 in VR segment 12. In the example shown, means 20 comprises a central processing unit 22. VR device 10 is further equipped with a position sensing device 24 for sensing the position and the movements of user 16 and of object 18 in VR segment 12. In the example shown, position sensing device 24 comprises four sensors 26 arranged in VR segment 12, with which the position and the movements of user 16 and of object 18 in VR segment 12 can be sensed and converted to corresponding signals. These signals are forwarded to central processing unit 22, for example via data lines (not shown).

Object 18, which is able to move freely in VR segment 12, has a surface 28, which is depicted schematically in FIG. 2 and which is provided with haptics that are adapted to the haptics to be anticipated according to the virtual reality.

Additionally, a total of three shaped elements 30₁ to 30₃ are detachably attached to object 18, the external shape of the shaped elements 30 being adapted to the external shape that would be anticipated according to the virtual reality. The central shaped element 30 is configured as an inflatable sleeve 32.

Object 18 may be embodied as a robot 34 or as a natural person. In the example shown, object 18 is embodied as a robot 34, but the following description also applies similarly to natural persons.

Robot 34 is able to move within VR segment 12 with drive means (not shown). Robot 34 is equipped with two movable sections 36 that point radially outward and can be moved at least perpendicular to the plane of the drawing in FIG. 1. One of the shaped elements 30₂, 30₃ is positioned at the free end of each movable section 36. Also attached to each of the movable sections 38 is a position sensor 38; these sensors communicate with position sensing device 24 and sense the movement of the movable sections 36.

VR device 10 further comprises a scent producer 40 for producing scents that are adapted to the scents to be anticipated according to the virtual reality.

VR device 10 is operated as follows: First, the motto of the virtual reality is established. For example, the virtual reality will take place in an old, abandoned house that is haunted by at least one monster. The corresponding virtual reality is stored in the central processing unit 22. Based on the design of the virtual reality, the external shape and the haptics the surface 28 of the monster must have in order to obtain a comprehensive immersion can be deduced. As depicted in FIG. 2, the monster is meant to have a fish-like, scaly, moist and slimy surface 28. Surface 28 of object 18 is designed accordingly, so that the haptics of object 18 are adapted to the haptics of the monster that would be anticipated according to the virtual reality. In the example shown, the surfaces 28 of shaped elements 30 are provided with these haptics.

As mentioned above, inflatable sleeve 32 forms the central shaped element 30₁. Inflatable sleeve 32 can be inflated such that it yields to a greater or lesser extent when touched. Since the example shown involves a monster that has a fish-like, moist, and slimy surface 28, inflatable sleeve 32 is inflated only enough that it yields significantly when touched.

The shaped elements 30 are also adapted to the external shape that would be anticipated according to the virtual reality. The movable sections 36 may represent flippers of the monster, for example, with the shaped elements 30₂, 30₃ arranged on the movable sections 38 being shaped accordingly.

As mentioned above, the virtual reality will take place in an old house, and the monster has a fish-like, moist, and slimy surface 28. The scent producer 40 therefore produces a musty decay-like scent.

Before at least one user 16 enters VR segment 12, he is given one of the head-mounted displays 21, which he puts on like glasses. He can then enter VR segment 12. The user is guided through corridors and up and down stairs in the old house, where he encounters the object 18 embodied as robot 34, which is able to move within VR segment 12 and which is presented as the monster to the user in the head-mounted display 21. The position and the movements of the user 16 are sensed by position sensing device 24 and are transmitted to central processing unit 22, which uses them to generate the corresponding virtual reality, which it transmits to head-mounted display 21, which displays the virtual reality to the user 16.

Robot 34 may be embodied as a walking robot that can move along the floor of VR segment 12 or may be suspended from the ceiling or the wall 14 of VR segment 12 by means of a rail system, along which robot 34 can be moved. Robot 34 is equipped with a route specifying means 42, which specifies one or more routes along which robot 34 will move within VR segment 12. Route specifying means 42 can be implemented, at least in part, in the form of an algorithm in the central processing unit 22. The route may be fixedly predefined or at least partially flexibly adapted to the given situation in VR segment 12. Robot 34 can be equipped with detection means (not shown) that enable it to locate a user 16. If route specifying means 42 specifies a fixed route, this can prevent robot 34 from coming too close to a user 16 and possibly injuring him. If such a situation is anticipated, robot 34 remains stationary until the user 16 in question has moved away or until robot 34 takes an alternate, but nevertheless predefined route. Still, robot 34 should be able to move close enough to user 16 that contact is possible and user 16 can sense the external shape and the haptics of robot 34.

If route specifying means 42 does not specify a fixed route, robot 34 can move toward a user 16 in such a way that the user 16 must come in contact with robot 34. As a consequence, the user 16 senses the haptics and the external shape of surface 28. Robot 34 can interact with the user 16 involved for an extended period of time and can follow him, for example, adapting to the speed at which the user 16 moves within VR segment 12.

Robot 34 can also make noises. For this purpose, a movable section (not shown) designed similarly to a jaw can be provided, which moves when robot 34 makes a noise. These noises are also designed to correspond to those that would be expected according to the virtual reality.

Once the user 16 has passed completely through VR segment 12, he leaves it and returns the head-mounted display 21.

### LIST OF REFERENCE SIGNS

10 VR device
12 VR segment
14 wall
16 user
18 object
20 means
21 head-mounted display
22 central processing unit
24 position sensing device
26 sensor
28 surface
30, 30₁-30₃ shaped elements
32 sleeve
34 robot
36 movable section
38 position sensor
40 scent producer
42 route specifying means

1. A VR device for generating and displaying a virtual reality, comprising
a VR segment (12) within which at least one user (16) and at least one object (18) can move freely, wherein the VR device
has means by which a virtual reality corresponding to the position and the movements of the user (16) and the object (18) within the VR segment (12) can be generated and can be displayed on a head-mounted display (21) assigned to the user (16), dependent on the position and the movement of the user (16) in the VR segment (12), and
has a position sensing device (24) for sensing the position and the movements of the user (16) and the object (18) in the VR segment (12),
wherein the object (18) has an external shape that is adapted, at least in terms of its geometric shape and size, to the external shape to be anticipated according to the virtual reality.

2. The VR device according to claim 1,
characterized in that the VR device (10) comprises one or more shaped elements (30), which can be attached to the object (18) and which have an external shape that is adapted to the external shape to be anticipated according to the virtual reality.

3. The VR device according to claim 1, characterized in that the object (18) has a surface, the haptics of which are adapted to the haptics to be anticipated according to the virtual reality.

4. The VR device according to claim 2, characterized in that the shaped element (30) is configured as an inflatable sleeve (32).

5. The VR device according to claim 3, characterized in that the surface is formed by the shaped element (30).

6. The VR device according to claim 1, characterized in that the object (18) has movable sections (36) and the position sensing device (24) has position sensors (38) that can be attached to the object (18) and can sense the movements of the movable sections (36).

7. The VR device according to claim 1, characterized in that the VR device (10) comprises a scent producer (40) for producing scents that are adapted to the scents to be anticipated according to the virtual reality.

8. The VR device according to claim 1, characterized in that the object (18) is a robot (34) or a natural person (34).

9. The VR device according to claim 1, characterized in that the VR device (10) comprises a route specifying means (42), which is configured such that the object (18) moves along a predefined route within the VR segment (12).

10. The VR device according to claim 1, characterized in that the VR device (10) comprises a route specifying means (42), which is configured such that the object (18) moves along a route that is not predefined within the VR segment (12).
